(19) United States
(12) Patent Application Publication
(10) Pub. No.: US 2026/0312915 A1
(43) Pub. Date: Oct. 8, 2026

(54) METHODS AND APPARATUS FOR HOSTING REAL TIME LAYER AND NON-REAL TIME LAYER IN A WIRELESS COMMUNICATION SYSTEM

(71) Applicant: Samsung Electronics Co., Ltd., Suwon-si, Gyeonggi-do (KR)

(72) Inventors: Nayan OSTWAL, Bangalore (IN); Aneesh DESHMUKH, Bangalore (IN); Mahantesh KOTHIWALE, Bangalore (IN); Anshuman NIGAM, Bangalore (IN)

(21) Appl. No.: 19/482,534

(22) PCT Filed: May 17, 2024
(86) PCT No.: PCT/KR2024/006703

§ 371 Date: Nov. 7, 2025

(30) Foreign Application Priority Data
May 18, 2023 (IN) 202341034970
Feb. 22, 2024 (IN) 202341034970

(51) Int. Cl. H04L 47/43; H04L 47/2416; H04L 69/321

(52) U.S. Cl. CPC H04L 47/43; H04L 47/2416; H04L 69/321

(57) ABSTRACT

The present disclosure relates to a 5G communication system or a 6G communication system for supporting higher data rates beyond a 4G communication system such as long term evolution (LTE). Embodiments herein provide a method and apparatus (301) to host real time layer and non-real time layer in a telecommunication network. The method includes detecting, by apparatus (301), a plurality of network layers. Further splitting a first set of network layers of the plurality of network layers into a real time layer and a second set of network layers of the plurality of network layers into a non-real time layer. Furthermore, hosting the RT layer (313) of the apparatus (301) for managing RT functionalities and the NRT layer (311) of the apparatus (301) for managing NRT functionalities of the telecommunication network.

### TECHNICAL FIELD

This application is based on and derives the benefit of Indian Provisional Application 20/234,1034970 filed on 18 May 2023, the contents of which are incorporated herein by reference. The proposed embodiments relate to a field of telecommunication network. More particularly the present disclosure relates to hosting real time (RT) layer and non-real time (NRT) layer in telecommunication network.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems. 6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure relates to wireless communication systems and, more specifically, the present disclosure relates to hosting real time layer and non-real time layer in a wireless communication systems.

### Solution to Problem

The principal object of the embodiments herein is provide a method and apparatus to host RT layer and NRT layer in a telecommunication network.

Another object of the embodiments herein is to segregate NRT and RT processing by providing NRT headers and RT headers for protocol processing.

Yet another object of the embodiments herein is to streamline the utilization of a solitary Sequence Number and offer Segment offset based Real Time processing, thereby harmonizing the transmission and reception handling across all scenarios.

Another object of the embodiments herein is to optimize the management of payloads contained within a transport block, achieved by maintaining consistent header information regardless of whether the packet has been completely transmitted or remains untransmitted.

Another object of the embodiments herein is to maintain status PDU framework utilizing segment offsets, without necessitating the retention of lost SDU counts.

Another object of the embodiments herein is to enable real time handling of packets using segmentation offset without the need for the sequence number.

Another object of the embodiments herein is to facilitate packet handling at the RT layer by minimizing the need for sequence numbers.

In one aspect, the objectives are achieved by hosting real time layer and non-real time layer in a telecommunication network. The method includes detecting, by the apparatus, a plurality of network layers. The plurality of network layers includes at least one of an application layer, Internet Protocol Layer, service data adaption protocol layer, packet data convergence protocol layer, radio link control layer, Medium access control layer and a physical layer. Further, the method includes splitting, by the apparatus, a first set of network layers of the plurality of network layers into a real time layer and a second set of network layers of the plurality of network layers into a non-real time layer. Thereafter, the method includes hosting, by the apparatus, the RT layer of the apparatus for managing RT functionalities and the NRT layer of the apparatus for managing NRT functionalities of the telecommunication network.

In an embodiment, the method of hosting includes for transmission, the RT layer for managing RT functionalities and the NRT layer for managing NRT functionalities of the telecommunication network comprises receiving, by the NRT layer of the apparatus, a plurality of Service Data Unit (SDU) packets. Furthermore, the method includes adding, by the NRT layer of the apparatus, a NRT header to the plurality of SDU packets, wherein the NRT header comprises Data or Control bit information, a sequence number and a length indicator of SDU packet. Thereafter, the method includes generating, by the NRT layer of the apparatus, a plurality of Protocol Data Unit (PDU) packets by concatenating the plurality of SDU packets. Also, the method includes determining, by the NRT layer of the apparatus, a PDU byte offset for each PDU packet of the plurality of PDU packets. Furthermore, the method includes generating, by the RT layer of the apparatus, a plurality of Transport Block (TB) by adding a RT header to a set of PDU packets of the plurality of PDU packets along with the corresponding PDU byte offset, wherein the RT header comprises a start byte offset of the set of PDU packets, a SDU boundary of the set of PDU packets, and a length indicator of the set of PDU packets. Thereafter, the method includes transmitting, by the RT layer of the apparatus, the plurality of TBs to the apparatus.

In an embodiment, the method to generate a plurality of TB by adding a RT header to the set of PDU packets of the plurality of PDU packets along with the corresponding PDU byte offset comprises transmitting, by the NRT layer of the apparatus, each PDU packet of the plurality of PDU packets along with the PDU byte offset of each PDU packet of the plurality of PDU packets to the RT layer. Furthermore, the method includes receiving, by the RT layer of the apparatus, each PDU packet of the plurality of PDU packets along with the PDU byte offset of each PDU packet of the plurality of PDU packets to the RT layer. Thereafter, the method includes storing, by the RT layer of the apparatus, each PDU packet of the plurality of PDU packets along with the PDU byte offset of each PDU packet of the plurality of PDU packets to the RT layer. Also, the method includes determining, by the RT layer of the apparatus, grants available at the apparatus. Further, the method includes generating, by the RT layer of the apparatus, the plurality of TB by adding the RT header to the set of PDU packets based on the grants available at the apparatus.

In an embodiment, the method to add the RT header to the set of PDU packets based on the grants available at the apparatus comprises determining, by the RT layer of the apparatus, whether the grants available at the apparatus is sufficient to add the RT header to the set of PDU packets. The method includes concatenating the set of PDU packets when the grants available at the apparatus is sufficient to add the RT header to the set of PDU packets, and adding the RT header to the set of concatenated PDU packets. Furthermore, the method includes segmenting the set of PDU packets into a plurality of subset of PDU packets when the grants available at the apparatus is not sufficient to add the RT header to the set of PDU packets, and adding the RT header to a subset of the plurality of subset of PDU packets.

In an embodiment, the method to add by the NRT layer (311) of the apparatus, the NRT header to the plurality of SDU packets comprises generating, by the NRT layer (311), the NRT header comprising the data or control bit information, the sequence number and the length indicator of SDU packet. The method includes adding the NRT header to each SDU packet of the plurality of SDU packets. Further, the method includes concatenating a set of SDU packets from the plurality of SDU packets and adding the NRT header to the set of concatenated SDU packet, wherein the set of SDU packets are predefined or randomly determined.

In an embodiment, the PDU byte offset for each PDU packet of the plurality of PDU packets are determined contiguously.

In an embodiment, the method includes receiving, by the RT layer (313) of the apparatus (301), the status PDU indicating the status of plurality of transmitted PDU packets. Further, the method includes determining, by the NRT layer (311), the set of not received PDU packets and the length of the set of not received PDU packets for retransmission based on the status PDU. Thereafter, the method includes retransmitting, by the NRT layer (311), the set of not received PDU packets to the apparatus.

In an embodiment, the method to host for reception, the RT layer (313) for managing RT functionalities and the NRT layer for managing NRT functionalities of the telecommunication network comprises receiving, by a RT layer of the apparatus, at least one TB from a plurality of TBs, wherein the at least one TB comprises a RT header associated with a set of PDUs. Further, the method includes obtaining, by the RT layer (313) of the apparatus (301), a start byte offset of the set of PDU packets, a SDU boundary of the set of PDU packets, and a length indicator of the set of PDU packets from the RT header of each TB of the plurality of TBs. Also, the method includes sending, by the RT layer of the apparatus, the set of PDU packets to a NRT layer of the apparatus, wherein each PDU packet is associated with a NRT header comprising Data or Control bit information, a sequence number and a length indicator of SDU packet. Further, the method includes obtaining, by the NRT layer of the apparatus, individual PDU packets by splitting the set of PDU packets based on the Data or Control bit information, the sequence number, the start byte offset of the PDU packet, and the length indicator of SDU packet. Thereafter, the method includes transmitting, by the NRT layer of the apparatus, a status PDU to the apparatus.

In an embodiment, the method includes determining by the NRT layer (311) of the apparatus, whether all TBs of the plurality of TBs are received based on the start byte offset of the set of PDU packets, the SDU boundary of the set of PDU packets, and the length indicator of the set of PDU packets. Further, the method includes starting, by the NRT layer (311) of the apparatus, a reassembly timer to receive remaining TB of the of the plurality of TBs when all TBs of the plurality of TBs are not received.

In an embodiment, the status PDU comprises the start byte offset of the set of received PDU packets, start byte offset of the set of not received PDU packets, length of the each of the not received PDU packet and total number of sets of PDU packets that are not received by the apparatus.

Accordingly, the embodiment herein is to provide an apparatus for splitting RT and NRT functionality in a telecommunication network. The apparatus comprises a processor and a hosting controller. The hosting controller is configured to detect a plurality of network layers. The plurality of network layers comprises at least one of an application layer, Internet Protocol Layer, service data adaption protocol layer, packet data convergence protocol layer, radio link control layer, Medium access control layer and a physical layer. Further, the hosting controller split a first set of network layers of the plurality of network layers into a real time layer and a second set of network layers of the plurality of network layers into a non-real time layer. Furthermore, the hosting controller hosts the RT layer of the apparatus for managing RT functionalities and the NRT layer of the apparatus for managing NRT functionalities of the telecommunication network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

According to an embodiment of the disclosure, a wireless communication can be performed efficiently. Especially, a hosting real time layer and non-real time layer in a wireless communication can be performed efficiently.

### BRIEF DESCRIPTION OF DRAWINGS

These and other features, aspects, and advantages of the present disclosure are illustrated in the accompanying drawings, throughout which like reference letters indicate corresponding parts in the various figures. The embodiments herein will be better understood from the following description with reference to the drawings, in which:

FIG. 1A is a schematic diagram that illustrates layered processing of IP packets, according to the prior art as disclosed herein;

FIG. 1B is a schematic diagram that illustrates a New Radio split architecture for IP packet processing, according to the prior art as disclosed herein;

FIG. 1C is a schematic diagram that illustrates a header processing of 4G IP packets, according to the prior art as disclosed herein;

FIG. 1D is a schematic diagram that illustrates a header processing of 5G IP packets, according to the prior art as disclosed herein;

FIG. 1E illustrates a header structure for LTE New PDU, according to the prior art as disclosed herein;

FIG. 1F illustrates a header structure for LTE segmented PDU, according to the prior art as disclosed herein;

FIG. 1G illustrates a header structure for LTE status PDU, according to the prior art as disclosed herein;

FIG. 1H illustrates a header structure for NR status PDU, according to the prior art as disclosed herein;

FIG. 1I illustrates a header structure for NR segmented PDU, according to the prior art as disclosed herein;

FIG. 1J illustrates a header structure for NR PDU, according to the prior art as disclosed herein;

FIG. 1K illustrates a scenario of packet processing in LTE at data link layer, according to the prior art as disclosed herein;

FIG. 1L illustrates a scenario of packet processing in NR at data link layer, according to the prior art as disclosed herein;

FIG. 2A is a flow diagram that illustrates packet processing during the transmission in NR at data link layer, according to the prior art as disclosed herein;

FIG. 2B is a flow diagram that illustrates packet processing during the reception in NR at data link layer, according to the prior art as disclosed herein;

FIG. 3A is a block diagram that illustrates an apparatus for splitting RT and NRT functionality in telecommunication network, according to the embodiment as disclosed herein

FIG. 3B is a block diagram that illustrates a split architecture of NRT layer and RT layer in telecommunication network, according to the embodiment as disclosed herein;

FIG. 4A is a packet structure including the NRT header and RT header, according to the embodiment as disclosed herein;

FIG. 4B depicts a NRT header structure for data PDU, according to the embodiment as disclosed herein;

FIG. 4C depicts a RT header structure for data PDU, according to the embodiment as disclosed herein;

FIG. 4D depicts a header structure for status PDU, according to the embodiment as disclosed herein;

FIG. 4E illustrates a scenario of packet processing during transmit procedure of SDUs through the NRT layer and RT layer, according to the embodiment as disclosed herein;

FIG. 5A is a flow diagram that illustrates a packet processing during transmit procedure of SDUs through the NRT layer and RT layer, according to the embodiment as disclosed herein;

FIG. 5B illustrates a scenario of packet processing during receive procedure of SDUs through the NRT layer and RT layer, according to the embodiment as disclosed herein;

FIG. 6A is a flow diagram that illustrates a packet processing during receive procedure of SDUs through the NRT layer and RT layer, according to the embodiment as disclosed herein;

FIG. 6B illustrates a scenario of retransmission procedure, according to the embodiment as disclosed herein;

FIG. 7A is a header structure of a NRT PDU, according to the embodiment as disclosed herein.

FIG. 7B is a header structure of a NRT PDU, according to the embodiment as disclosed herein.

FIG. 7C is a header structure of a NRT PDU, according to the embodiment as disclosed herein.

FIG. 8 is a flow diagram that illustrates a method of hosting real time layer and non-real time layer in telecommunication network, according to the embodiments herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

According to the 3GPP New Radio (NR) specification, a modem typically manages IP packets from various applications, with packet sizes varying from a few tens of bytes to thousands of bytes. The maximum size of an Internet Protocol (IP) packet can be up to 9k bytes du to Ethernet jumbo frame size limitations. Each packet is then processed at each layer, where one IP packet is equivalent to one Packet Data Convergence Protocol Service Data Unit (PDCP SDU), which in turn is equivalent to one PDCP Protocol Data Unit (PDU) with one PDCP Sequence Number (SN), one Radio Link Control (RLC) SDU, and one RLC PDU with one RLC SN.

At the Medium Access Control (MAC) layer, based on the grant received (i.e., the size of the transport block (TB) that can be sent over the PHY layer in one transmission opportunity), multiple RLC PDUs are transmitted over the Physical layer (PHY) as one MAC TB. The MAC layer concatenates multiple RLC PDUs from the same or different bearers into a single MAC TB. Grants are received in terms of bytes, and they are allocated for the entire User Equipment (UE). Thus, upon rser eceiving a grant, the MAC layer must decide on the scheduling of the received grants to different Radio Bearers (RBs), and based on the allocated grant, the respective RLC layer can pack its PDUs and deliver them to MAC.

Segmentation of RLC PDU is the only real-time processing required for the entire MAC PDU, while the rest of the functionality can be done in non-real-time. However, handling segmentation still requires two SNs along with segment offset information, which adds an overhead in processing.

With the emergence of LTE (4G) and NR (5G), a plethora of applications have surfaced, propelling towards extensive utilization of channel bandwidth and reduced latency, ultimately elevating the user experience. High Definition Video Streaming, Augmented Reality (AR)/Virtual Reality (VR), Holography, and Digital Twin are a few examples that necessitate dedicated processing with stringent requirements. High throughput, low latency, and zero jitter are crucial components that must be met simultaneously. The future application Key Performance Indicator (KPI) requirements are illustrated in Table 1 below.

TABLE 1

| KPI | 4K/8K | | AR/VR | Holography | | Digital Twin |
|---|---|---|---|---|---|---|
| Max | 35-140 | Mbps | 25 Mbps-5 G bps | 4-10 | Tbps | Peak: 10-100 Gbps |
| Throughput | | | | | | Average: 1-10 Gbps |
| Max Bounded | 15-35 | ms | 5-7 ms | 1-7 | ms | 0.1 ms-100 ms |
| Latency | | | | | | |

The current processing stack adheres to a hierarchical structure, with the Application Layer, Transport Layer, Internet Protocol, and RAN Protocol in order of precedence. As a result, Next Generation immersive applications with stringent KPI requirements for latency, throughput, and jitter necessitate a more stringent and streamlined packet processing approach to enhance the overall user experience.

It is desired to address the above-mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments discloses a method of splitting real time and non-real time functionality in the telecommunication network. The method includes detecting, by an apparatus, a plurality of network layers. The plurality of network layers includes at least one of an application layer, Internet Protocol Layer, service data adaption protocol layer, packet data convergence protocol layer, radio link control layer, Medium access control layer and a physical layer. Further, the method includes splitting a first set of network layers of the plurality of network layers into a real time layer and a second set of network layers of the plurality of network layers into a non-time layer. Furthermore, the method includes hosting by the apparatus, the RT layer of the apparatus for managing RT functionalities and the NRT layer of the apparatus for managing NRT functionalities of the telecommunication network.

Accordingly, the embodiments discloses an apparatus for splitting real time and non-real time functionality in the telecommunication network. The apparatus comprises a processor and a hosting controller. The hosting controller is communicatively coupled to the processor. The hosting controller is configured to detect a plurality of network layers.

Particularly, during transmission, the hosting controller hosts the RT layer for managing RT functionalities and the NRT layer for managing NRT functionalities is configured to detect a plurality of network layers. The plurality of network layers includes at least one of an application layer, Internet Protocol Layer, service data adaption protocol layer, packet data convergence protocol layer, radio link control layer, Medium access control layer and a physical layer. Further, the hosting controller split a first set of network layers of the plurality of network layers into a real time layer and a second set of network layers of the plurality of network layers into a non-real time layer. Furthermore, the hosting controller hosts the RT layer of the apparatus for managing RT functionalities and the NRT layer of the apparatus for managing NRT functionalities of the telecommunication network.

The current innovation tackles the challenges of high processing overheads and complex packet processing solutions, while also addressing the tight coupling between the RLC and MAC layer in both NR and LTE. The proposed solution presents a novel approach through a split network architecture, consisting of a real-time layer and non-real-time layer. The real-time layer handles real-time functionalities, while the non-real-time layer manages non-real-time functionalities.

When hosted on a server, the Centralized Unit comprises a non-real-time layer, while the distributed unit comprises a real-time layer and physical layer. This split architecture reduces management and scaling costs, while also meeting strict real-time latency requirements. Additionally, the proposed solution can be hosted on user equipment.

The solution also simplifies the protocol by using only one sequence number at the NRT layer and reducing the number of flags in the packet header structure. This loose coupling is achieved by splitting the real-time and non-real-time functionalities, ensuring that there is no dependency of the MAC grants on the non-real-time functionalities. Furthermore, when required, segmentation can be performed by the MAC layer itself.

In an existing technique, discloses a method for transmitting data packets from a transmitter to a receiver, all within the confines of a single radio link control entity. The method involves transmitting lower priority data blocks, which contain data segments of a first higher layer packet linked to a lower priority first packet flow context (PFC) that is uniquely identified by a first temporary flow identifier (TFI). Additionally, the transmission of said first higher layer packet is interrupted before it is fully transmitted. The method also entails transmitting higher priority data blocks that contain data segments of a second higher layer packet associated with a higher priority second PFC. This transmission indicates the interruption of the first higher layer packet's transmission. Finally, the transmission of the first higher layer packet is resumed from the point of interruption.

Thus, the previously disclosed technique addresses the priority-based issues that arise when using a common RLC entity. It provides a method and apparatus for interrupting the transmission/reception of lower priority higher layer packets to transmit/receive higher priority higher layer packets within the context of a common RLC entity. The technique also utilizes Packet Flow Context (PFC) and Temporary Flow Identifier (TFI).

One of the existing techniques involves a sophisticated approach for wireless communication systems, wherein data transmission is carried out without the use of sequence numbers. The method entails the generation of a data PDU that comprises an indicator that specifies whether a sequence number is incorporated in the data PDU. Subsequently, the data PDU that does not contain the sequence number is transmitted to the network, without updating state variables, based on the indicator that confirms the absence of the sequence number in the data PDU. This particular technique is utilized in a specific scenario where recovery is not needed, and thus, no window state variable is updated.

Another conventional technique has been disclosed, which presents a sophisticated method and device for executing RLC retransmission on the basis of contention-based PUSCH in a wireless communication system. The method comprises retransmitting the RLC PDU that had been originally transmitted on the contention-based PUSCH. Additionally, the method takes into account the HARQ Feedback to be utilized by RLC for considering ACK/NACK and performing retransmission if NACKed. While the existing technique emphasizes maintaining the transmission/reception window by using the number of bytes transmitted and recovering the loss of packets, it fails to address the splitting of real-time functionalities and non-real-time functionalities during packet processing.

Another technique presently in use involves the transmission of RLC layer status reports through a method and apparatus. This method entails the indication of the Segment Offset field in the event of NACK_SN and NACK_SN Range being present in the status PDU. The Segment Offset is defined as the Data PDU offset of a specific SN. However, this technique defines the byte offset for the entire data stream rather than just a particular PDU. Additionally, both sequence number and segment offset are indicated during data transmission and in the status PDU, resulting in increased processing overhead at the receiver's end.

However, current techniques and methodologies fail to bifurcate the actual time-sensitive processing from the non-time-sensitive processing of IP packets while transmitting or receiving them.

The technical solution proposed herein presents a split network architecture that consists of a real-time layer and a non-real-time layer. The real-time layer is responsible for executing real-time functionalities, while the non-real-time layer takes care of non-real-time functionalities. When hosted on a server, the Centralized Unit comprises a non-real-time layer, whereas the distributed unit comprises a real-time layer and a physical layer. The non-real-time functionalities hosted at the CU help reduce management and scaling costs, while the RT functionalities hosted at the DU meet strict real-time latency requirements. Moreover, this split architecture can be hosted at user equipment as well.

The proposed solution also offers a simplified protocol, with only one sequence number used at the NRT layer. The header structure of the packets is also simplified, with a reduced number of flags. Furthermore, the proposed solution ensures loose coupling by separating real-time functionalities and non-real-time functionalities. This way, there is no dependency of the MAC grants on non-real-time functionalities. Additionally, segmentation, when necessary, can be performed by the MAC layer itself.

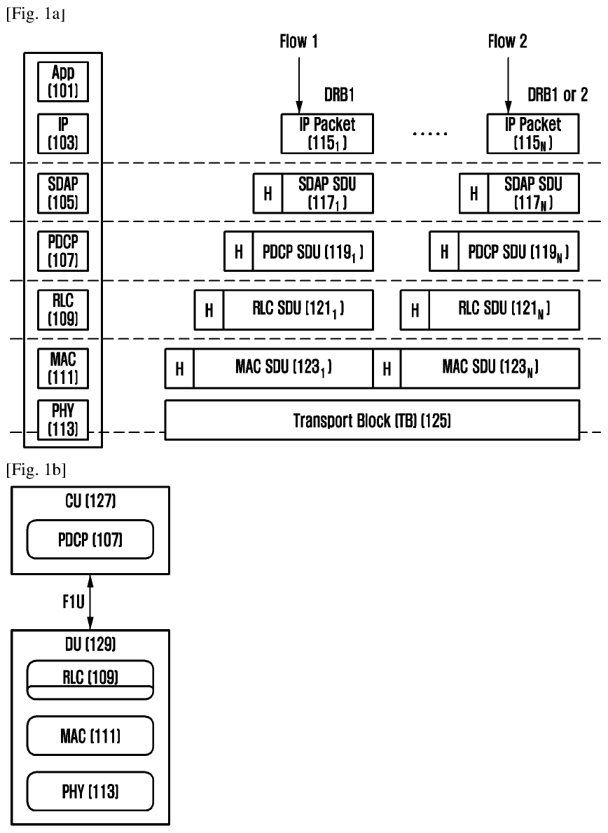

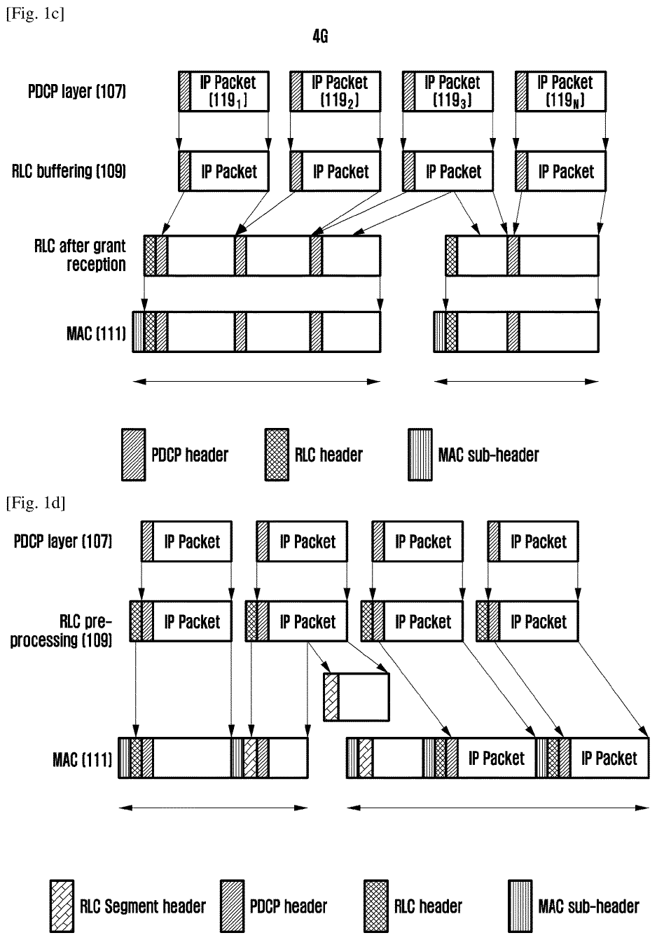

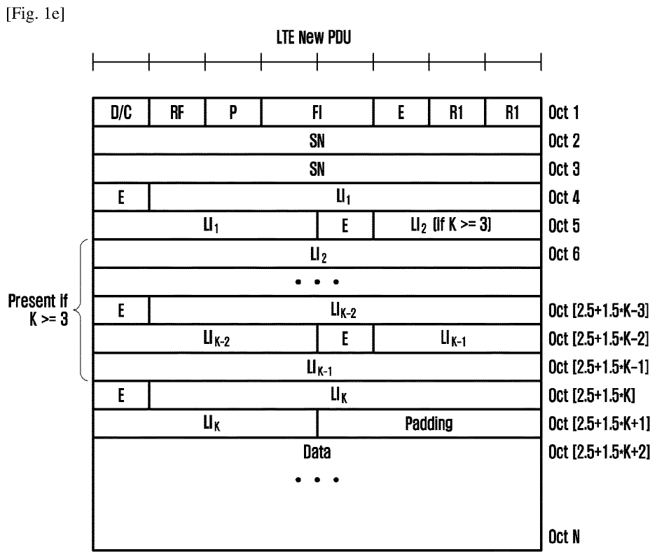

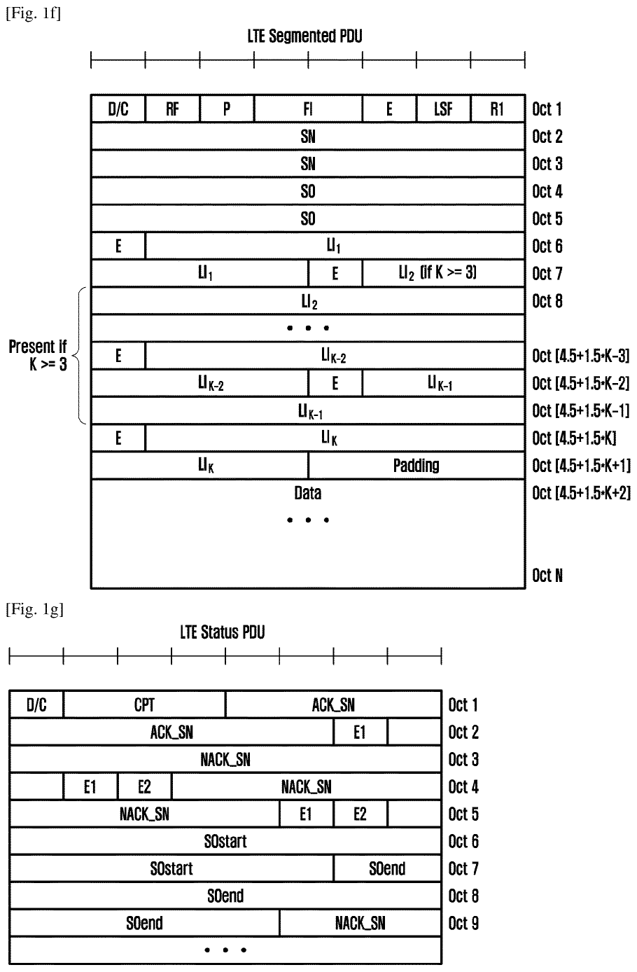

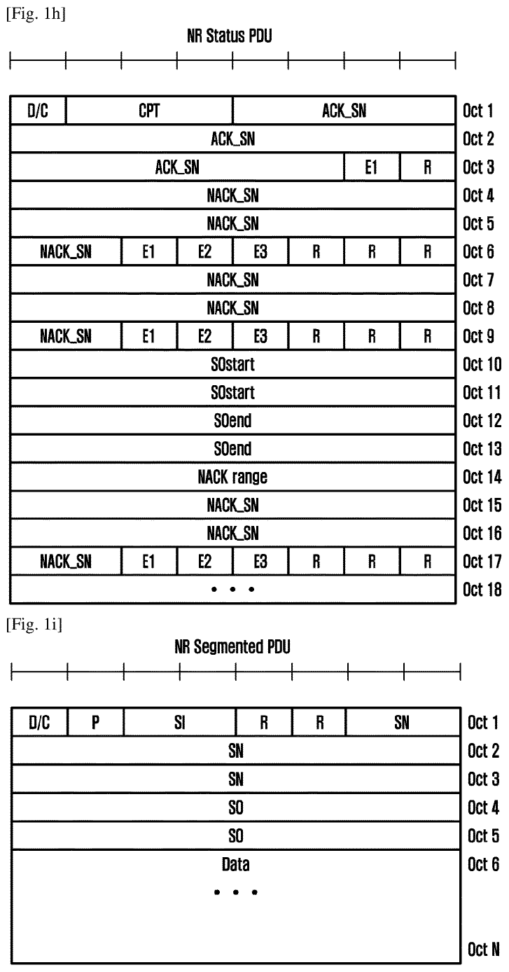

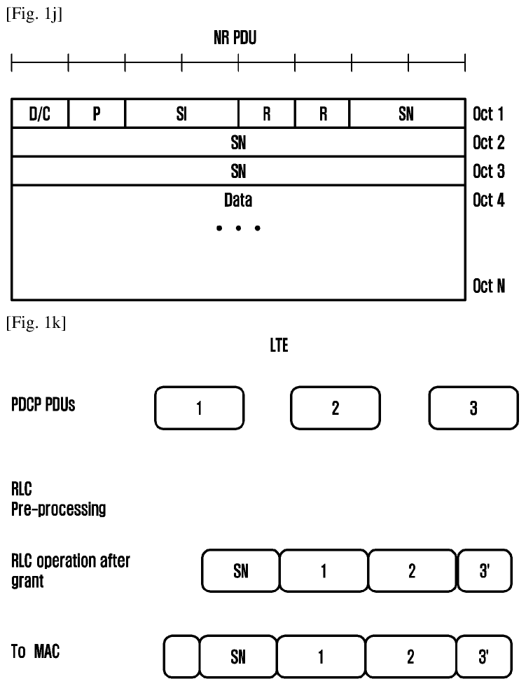

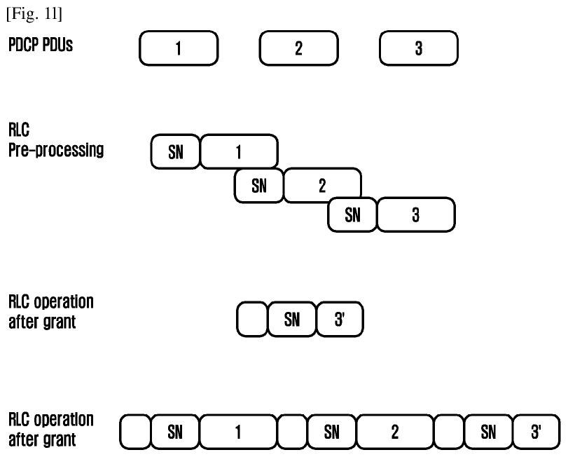

FIG. 1A is a schematic diagram that illustrates layered processing of IP packets, according to the prior art as disclosed herein. FIG. 1A illustrates how NR IP packets can be mapped to the same or different DRBs, depending on the source application. For instance, IP packets from Flow 1 may be assigned to DRB 1, while those from Flow 2 can be assigned to DRB 1 or DRB 2. Additionally, IP packets received by the IP layer (103) from the application layer (101) are referred to as Service Data Units (SDUs) (1151-115N). These SDUs are then transmitted to the SDAP layer (105), which adds a header to each SDU to create an SDAP PDU (1171-117N). The resulting SDAP PDUs are then forwarded to the PDCP layer (107), where the header is added to form PDCP PDUs (1191-119N). The PDCP PDUs are subsequently transmitted to the RLC layer (109), where headers are added to create RLC PDUs (1211-121N). The MAC layer (111) then adds headers to each of the RLC PDUs to form MAC PDUs (1231-123N), which are concatenated and transmitted as transport blocks (125) by the physical layer (113). While RLC functionalities are non-real time, save for segmentation handling and MAC grant handling, each layer involves significant header processing, resulting in considerable latency. Therefore, there is a need for an improved IP packet processing system that can efficiently handle both real-time and non-real-time processing.

FIG. 1B is a schematic diagram that illustrates a New Radio split architecture for IP packet processing, according to the prior art as disclosed herein. As depicted in the FIG. 1B, in the legacy protocol layers of the telecommunication network, the PDCP layer (107) is hosted in the Centralized Unit (CU) (127), while the RLC layer (109), the MAC layer (111), and the PHY layer (113) are hosted in the Decentralized Unit (DU) (129). In the CU-DU split architecture, the CU (127) is situated in a data center that is located far away from the cell site, making it easier to maintain the stored data. However, due to transmission delays, the CU (127) cannot perform any real-time operations. On the other hand, the DU (129) is located near or at the cell site, allowing it to perform all real-time functionalities. Nonetheless, scaling and maintaining the data at the DU (129) is more expensive. Most of the functionalities at the RLC layer (109) are non-real-time, except for the segmentation of IP packets. Therefore, the RLC layer (109) is mainly hosted in the DU (129) for the purpose of segmentation, as the rest of the functionalities are non-real-time. Consequently, maintaining the RLC layer (109) and the functionalities it performs is challenging when it comes to scaling and maintenance at the DU (129).

In the context of CU-DU split architecture, the processing of packets at the PDCP layer (107) and the RLC layer (109) necessitates a significant amount of computational resources and intricate solutions. This is due to the fact that both the PDCP layer (107) and RLC layer (109) allocate a unique sequence number to each of the PDCP PDUs (1191-119N) and RLC PDUs (1211-121N), which results in additional processing requirements at both the transmitting and receiving ends. Furthermore, the utilization of different conditional flags, such as re-segmentation Flag SI LSF and SOStart and SOEnd in the PDCP headers and RLC headers, to indicate segment information at the RLC layer (109), contributes to the complexity of the header structure.

The RLC layer (109) and the MAC layer (111) exhibit a strong interconnection, particularly in LTE. The RLC layer concatenates the SDUs according to the grant, and the MAC grants are essential for the formation of the entire RLC PDU. Similarly, in NR, the RLC SDU is segmented based on the reception of the grant. This interdependency necessitates the need to overcome the tight coupling between the RLC layer (109) and the MAC layer (111) in both LTE and NR.

FIG. 1C is a schematic diagram that illustrates a header processing of 4G IP packets, according to the prior art as disclosed herein. As shown in FIG. 1C, illustrates a legacy packet processing in 4G/LTE between the PDCP layer (107), RLC layer (109) and the MAC layer (111). In 4G/LTE, the IP packets (1191-119N) received from PDCP layer (107) are concatenated at RLC layer (109). At the RLC layer (109) a RLC Sequence Number (SN) is assigned to the RLC Protocol Data Unit (PDU) only after grant reception from the network. The grant received is the transmission opportunity provided by the network to the UE in the form of number of bytes to be transferred. One RLC PDU consisted of a variable number of RLC Service Data Units (SDU) s (1211-121N). 1 RLC SDU=1 PDCP PDU (119). Each PDCP PDU had 1 PDCP SN. In 4G/LTE the RLC pre-processing is not possible because the number of RLC SDUs to be packed is dependent on the grant size. However, due to the variable number of PDCP Packets in RLC PDU, the RLC header is variable in size. The variable size of the RLC header has extra fields of resegmentation, SI and LSF to indicate the SDU boundaries. Thus, in 4G/LTE with low throughput requirement and concatenation at RLC layer (109), the number of RLC SN needed are less and the RLC SN range is just 10-bit number (1024). However, in 4G/LTE the RLC header is variable in size and no pre processing of RLC SDUs is possible, thus leading to the processing overhead at the receiver side.

FIG. 1D is a schematic diagram that illustrates a header processing of 5G IP packets, according to the prior art as disclosed herein. As shown in FIG. 1D, in 5G/NR, to allow pre-processing and introduce fixed size RLC header, RLC SN is allocated to every RLC SDU (1211-121N). In 5G/NR one IP Packet is equal to 1 PDCP SDU. Further a sequence number is assigned in header to every PDCP SDU to form PDCP PDU 1. Further, at RLC layer (109), sequence number is assigned to every PDCP PDU, where 1PDCP PDU is equal to 1 RLC SDU. Real time processing is limited to only segmentation at RLC layer (109) where if a complete RLC SDU (1211-121N) cannot be packed in a MAC TB (Transport Block). During segmentation, the RLC layer (109) adds the segment header after receiving the MAC grants and adds the Segment Offset information to the header. Also, the Resegmentation field is not required in NR, but SI and SO fields are present to indicate the Segment information. However, the segmentation makes the RLC transmission (Tx) functionality to be done in real time and tightly coupled with the MAC grants. However, each RLC PDU is assigned a MAC Subheader and hence the number of Headers required are larger as compared to LTE, but pre-processing helps in faster processing of the packet. The number of RLC SNs required is large and supported up to 18-bit SN i.e. 262144.

FIG. 1E-FIG. 1F illustrates a header structure for LTE New PDU and LTE segmented PDU for RLC layer, according to the prior art as disclosed herein. The framing information (FI) field is updated to inform whether the first byte and the last byte of the RLC PDU correspond to the first byte and the last byte of an RLC SDU, respectively. The extension field (E) indicates whether a data field follows to indicate the end of the header or another extension follows or not. Particularly, a set of E fields and LI fields follows. The length indicator field (LI) indicates the length of the RLC SDU. In 4G, the E and LI fields are not added, corresponding to the last concatenated PDCP PDU. The Sequence number (SN) is added to each of the RLC SDU. Also, the sequence number can be max of 10 bits. The Segment Offset (SO) indicates the position of the RLC PDU segment in bytes within the original RLC PDU. The D/C field indicates whether the RLC PDU is a data PDU or a status PDU. When the RLC PDU is a data PDU then D/C bit is “1”. Similarly, the when the RLC PDU is a control PDU then D/C bit is “0”. Resegmentation Flag (RF) field indicates whether the RLC PDU is a new PDU or a segmented PDU. The Polling (P) field indicates whether a request for the transmission status PDU is initiated. The Reserved 1 (R1) field is reserved for future version of the protocols.

FIG. 1G illustrates a header structure for LTE status PDU, according to the prior art as disclosed herein. The LTE status PDU is transmitted is sent from the receiver to transmitted to indicate the status about the successfully received RLC PDUs and lost RLC PDUs. The Control PDU type (CPT) indicates the type of the status PDU. However, in LTE there is only one control PDU type. The Acknowledgment SN (ACK SN) is a 10 bit long field that indicates the sequence number of the next not received RLC data PDU which is not reported as missing in the status PDU. The extension (E1) field indicates whether or not a NACK_SN, E1 and E2 follows. Also, extension (E2) indicates whether or not a set of Sostart and SO end follows. For example, “0” indicates that a set of SOstart and SOend does not follow for this NACK_SN. Similarly, “1” indicates that a set of SOstart and Soend follows for this NACK_SN.

FIG. 1H illustrates a header structure for NR status PDU, according to the prior art as disclosed herein. In the context of the NR, a header is added to each RLC SDU. Consequently, when the concatenated RLC PDU is transmitted to the receiver, the status information pertaining to each RLC SDU must be included. This is achieved by specifying various fields within the status header. However, providing status information for each RLC PDU results in a significant processing overhead at the receiver side. Additionally, the fields within the RLC status PDU header are byte aligned. The presence of NACK_range in the header is indicated by E3.

FIG. 1I-1J illustrates a header structure for NR PDU and NR segmented PDU, according to the prior art as disclosed herein. As concatenation is absent at the RLC layer (109) in NR, the Length Indicator field is not present. However, each RLC SDU is assigned a sequence number. In the case of a segmented packet, a segment offset field is included in the NR segmented RLC PDU.

FIG. 1K illustrates a scenario of packet processing in LTE at data link layer, according to the prior art as disclosed herein. FIG. 1K demonstrates the process of handling packets at the PDCP layer (107) and RLC layer (109) in 4G/LTE. Initially, PDCP PDUs (1, 2, 3) are transmitted from the PDCP layer (107) to the RLC layer (109) where they are buffered upon reception. Once a grant is received from the network, the RLC layer (109) concatenates the PDCP PDUs (12, 3′) based on the grant received. During the concatenation process, the PDCP PDU (3) may be segmented. Additionally, the RLC header is added to the concatenated PDCP PDU (12, 3′) to form the RLC PDU, and a sequence number is assigned to the concatenated packet (123′). The RLC PDU is then transmitted to the MAC layer (111) for further processing, where a MAC header is added to form a MAC PDU. Finally, the MAC PDU is transmitted through a physical channel to the receiver. As a result of this process, only a single sequence number is assigned to the group of PDCP PDUs after the reception of the grant from the network, reducing the number of RLC sequence numbers added and potentially decreasing processing overhead at the receiver side. However, it should be noted that the size of the RLC PDU may vary in LTE/4G, and there is no pre-processing of the PDCP PDUs at the RLC layer (109).

FIG. 1L illustrates a scenario of packet processing in NR at data link layer, according to the prior art as disclosed herein. FIG. 1L illustrates the process of packet handling at the PDCP layer (107) and RLC layer (109) in 5G/NR. The PDCP PDUs (1, 2, 3) are transmitted from the PDCP layer (107) to the RLC layer (109), where a RLC header is added to each of the received PDCP PDUs (123) to form the RLC PDUs (1, 2, 3). The RLC layer (109) also adds a sequence number to each PDCP PDU (1, 2, 3) and buffers them. Upon receiving the grant, one or more RLC PDUs (1, 2, 3′) are concatenated based on the grant received and transmitted to the MAC layer (111) for further processing.

In 5G/NR, the RLC header is added to each PDCP PDU at the RLC layer (109), resulting in a fixed size of the RLC header that does not vary. Additionally, pre-processing of packets is performed at the RLC layer (109) before the reception of the grant, leading to faster processing of packets. The 5G/NR also includes efficient segmentation information.

However, at the MAC layer (111) in 5G/NR, each PDCP PDU is assigned a MAC sub header, resulting in a large number of headers and sequence numbers. This leads to processing overhead at the receiver side. Therefore, there is a need for an improved packet processing and handling method for IP packets during transmission and reception over wireless communication networks.

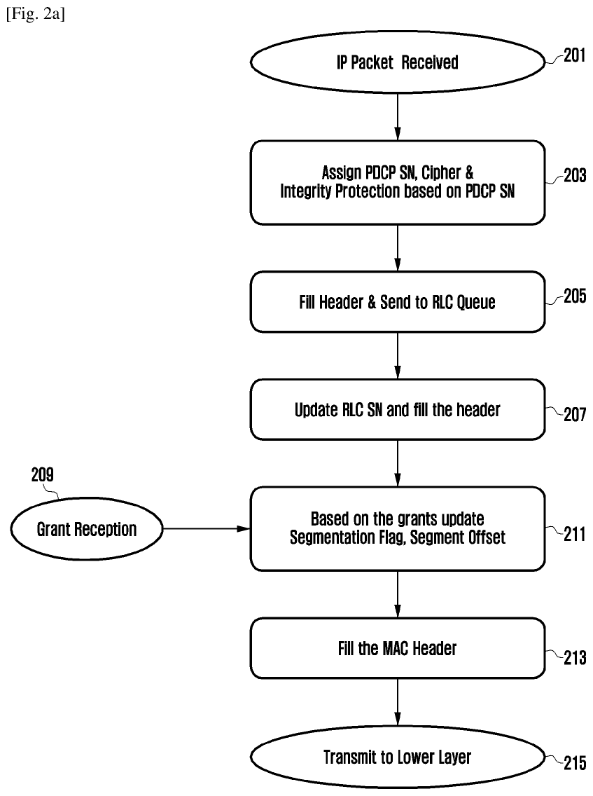

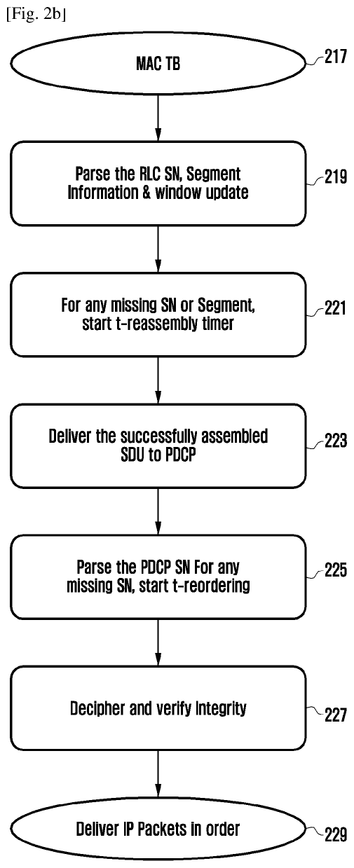

FIG. 2A is a flow diagram that illustrates packet processing during the transmission in NR at data link layer, according to the prior art as disclosed herein. At block 201, the one or more IP packets, at a transmitter, can be received from upper layer to a PDCP layer (107).

At block 203 within the PDCP layer (107) of the transmitter, a PDCP sequence number is appended to each IP packet received from the upper layer. Additionally, the one or more IP packets undergo ciphering and integrity protection based on the PDCP SN, utilizing select ciphering techniques.

Further, at block 205, the PDCP layer (107) adds a PDCP header to each IP packet to create PDCP PDUs. These PDUs are then transmitted to the RLC layer (109), where they are buffered.

At block 207, the RLC layer (109) at the transmitter assigns a new RLC sequence number to each PDCP PDU and adds an RLC header to form RLC PDUs. Finally, at block 209, the RLC layer (109) receives a grant from the network, representing the amount of data that can be transmitted via the wireless communication network.

At block 211, upon the reception of the grant, the RLC layer (109) at least one of concatenates or segments the one or more RLC PDUs based on the reception of the grants. Upon the concatenation or segmentation, some of the fields in the RLC header such as segmentation flag and segmentation offset is updated accordingly. Upon filling the RLC header details, the concatenated or segmented RLC PDUs are transmitted to the MAC layer (111).

At block 213, at the transmitter, at the MAC layer (111) a MAC header is added to the concatenated or segmented RLC PDUs to form the MAC PDUs.

At block 215, Furthermore, the MAC layer (111) transmits the one or more MAC PDUs to the lower layers. Particularly, the one or more MAC PDUs can be transmitted to the physical layer (113). Moreover, the physical layer (113) transmits transport block towards the receiver side.

FIG. 2B is a flow diagram that illustrates packet processing during the reception in NR at data link layer, according to the prior art as disclosed herein.

At block 217, at receiver, the MAC layer (111) receives the transport block from the transmitter. Also, the MAC layer (111) transmits to the RLC layer (109) on the receiver.

At block 219, the RLC layer (109) of the receiver side, parses the RLC sequence number, segment information and window update.

At block 221, Upon parsing, the RLC layer (109) determines whether all the RLC PDUs are received successfully. Also, the RLC layer (109) determines any missing sequence number or segment. When a missing segment is determined, then the RLC layer (109) starts the reassembly timer.

At block 223, Furthermore, the RLC layer (109) transmits the successfully assembled RLC SDUs to the PDCP layer (107).

At block 225, the PDCP layer (107) at the receiver side parses the PDCP SN and determines whether any missing PDCP SN. When a missing SN is determined, then a t-reordering timer is started.

At block 227, upon parsing, the PDCP layer (107) deciphers and verifies the integrity of the received IP packets from the transmitter.

At block 229, Upon the successful verification the PDCP layer transmits the one or more IP packets are transmitted to the upper layers of the receiver side at block (229).

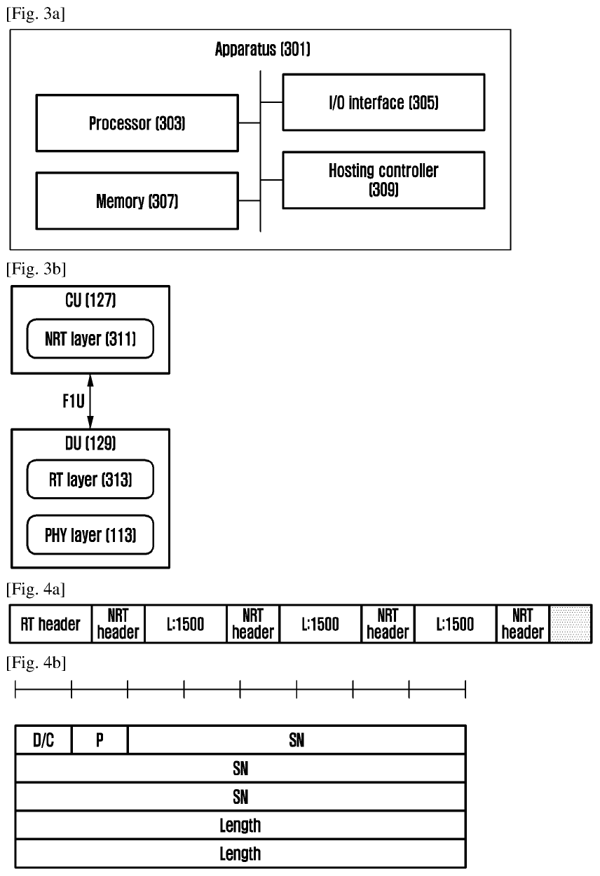

FIG. 3A is a block diagram that illustrates an apparatus for splitting RT and NRT functionality in telecommunication network, according to the embodiment as disclosed herein. The apparatus (301) includes a processor (303), a memory (307), and an I/O interface (305) and a hosting controller (309). The apparatus can be at least one of a user equipment or a network apparatus. In an embodiment, the apparatus can be at least one of a transmitter device and a receiver device. Further, the processor (303) of the apparatus (301) communicates with the memory (307), the I/O interface (305) and the hosting controller (309). The processor (303) is configured to execute instructions stored in the memory (307) and to perform various processes. The processor (303) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (307) of the apparatus (301) includes storage locations to be addressable through the processor (303). The memory (307) is not limited to a volatile memory and/or a non-volatile memory. Further, the memory (307) can include one or more computer-readable storage media. The memory (307) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (307) can store the media streams such as audios stream, video streams, haptic feedbacks and the like. The memory (307) can store several header information added at each real time layer and non-real time layer of the. Also, the memory stores information required for the packet processing at the real time layer and the non-real time layer.

The I/O interface (305) transmits the information between the memory (307) and external peripheral devices. The peripheral devices are the input-output devices associated with the apparatus (301). The I/O interface (305) receives several information from the receiver side apparatus or transmitter side apparatus. The several information received from the receiver side apparatus or transmitter side apparatus can include but not limited to the header information of the real time layer and the non-real time layer.

The hosting controller (309) is an innovative hardware that is realized through the physical implementation of both analog and digital circuits, including logic gates, integrated circuits, microprocessors, microcontrollers, memory circuits, passive and active electronic components, as well as optical components

The hosting controller (309) communicates with the I/O interface (305) and the memory (307) for splitting RT and NRT functionality in a telecommunication network. The hosting controller (309) of the apparatus (201), detects a plurality of network layers. Further, the hosting controller (309) splits a first set of network layers of the plurality of network layers into a real time (RT) layer and a second set of network layers of the plurality of network layers into a non-real time (NRT) layer. Furthermore, the hosting controller (309) hosts the RT layer for managing RT functionalities. Similarly, the hosting controller (309) hosts the NRT layer for managing the NRT functionalities of the telecommunication network. The RT functionalities are the functions which are performed in real time. For example, the segmentation handling of IP packets can be referred to as the RT functionalities. Similarly, the NRT functionalities are the functions which can be handled in non-real time. For example, the concatenation of IP packets or header processing of IP packets can be referred to as the NRT functionalities.

The hosting controller (309) of apparatus can manage the real time functionalities and non-real time functionalities when the apparatus is performing the transmission procedure or the receiving procedure. For example, the transmission procedure can include the transmission of plurality of IP packets from a transmitter device to a receiver device. Also, the receiving procedure can include the receiving of the plurality of IP packets transmitted from the transmitter device.

While, the apparatus is performing a transmission procedure, the plurality of the IP packets are received by the NRT layer from the application layer. The plurality of IP packets can be herein after referred to as SDU packets. Further, the NRT layer adds the NRT header to the plurality of SDU packets. The NRT header comprises at least one of Data or Control bit information, a sequence number and a length indicator of SDU packet. Further, the NRT layer generates a plurality of Protocol Data Unit (PDU) packets by concatenating the plurality of SDU packets. Furthermore, the NRT layer determines PDU byte offset for each PDU packet of the plurality of PDU packets. Thereafter, the NRT layer transmits the plurality of PDU packets to the RT layer. Upon receiving the plurality of PDU packets, the RT layer generates a plurality of Transport Block (TB) by adding a RT header to the set of PDU packets of the plurality of PDU packets along with the corresponding PDU byte offset. The RT header comprises a start byte offset of the set of PDU packets, a SDU boundary of the set of PDU packets, and a length indicator of the set of PDU packets. Ultimately, the RT layer transmits the plurality of TBs to the receiver device.

While the apparatus is performing receiving procedure, the apparatus can be a receiver device. Upon receiving the plurality of TBs from the transmitter device, the RT layer of the apparatus, obtains a start byte offset of the set of PDU packets, a SDU boundary of the set of PDU packets, and a length indicator of the set of PDU packets from the RT header of each TB of the plurality of TBs. Furthermore, the RT layer sends the set of PDU packets to a NRT layer of the apparatus. Each of the PDU packet from the set of the PDU packets is associated with the NRT header. The NRT header can include but not limited to Data or Control bit information, the sequence number and the length indicator of SDU packet. Thereafter, the NRT header obtains individual PDU packets by splitting the set of PDU packets based on the Data or Control bit information, the sequence number, the start byte offset of the PDU packet, and the length indicator of SDU packet. Ultimately, the NRT layer transmits the status PDU to the transmitter device based on the successful reception of the PDU packets and unsuccessful reception of the PDU packets. Also, the NRT layer transmits the successfully received PDU packets to the upper layers at the receiver side.

FIG. 3B is a block diagram that illustrates a split architecture of NRT layer and RT layer in telecommunication network, according to the embodiment as disclosed herein. The apparatus can be at least one of a user equipment or a server. When the apparatus is a server, then the hosting of the RT layer and the NRT layer is split in CU and DU. Particularly, the NRT layer (311) is hosted at the CU (127) and the RT layer (313) is hosted at the DU (129). The NRT layer (311) performs the non-real time functionalities of the IP packet processing at the CU (127) and the RT layer (313) performs the real time functionalities of the IP packet processing at the DU (129). The NRT functionalities being performed at the CU (127) reduces the management and scaling costs. Similarly, the RT functionalities being performed at the DU (129) meets the strict real time latency. Also, the NRT layer adds a NRT header to each of SDU packets received from the upper layers. The upper layer can be at least one of the application layer, presentation layer, session layer, transport layer and network layer. The NRT header added at the NRT layer includes simplified fields. The one or more fields includes a sequence number and the length indicator. The sequence number is a unique number assigned to the SDU packet that can be used for identification of the SDU packets at the receiver side. Also, the length indicator indicates the length of the SDU packet. Upon adding the NRT header, the NRT layer generates a plurality of PDU packets by concatenating or segmenting the one or more SDU packets. Furthermore, the plurality of PDU packets are transmitted to the RT layer (313). The RT layer (313) adds the RT header to plurality of concatenated PDU packets or segmented PDU packet. The RT layer does not assign a new sequence number to concatenated PDU packet or the segmented PDU packet. Thus, there is only one sequence number associated with the PDU packet. The RT header comprises some of the fields that include but not limited to E bit, length indicator, Logical Channel ID (LCID), byte offset and SDU boundary. The byte offset of the SDU packet is indicated at the NRT layer (311). The byte offset value is a contiguous for each of the SDU packet. Thus, both the NRT header and the RT header has a simplified structure and also has reduced number of flags. Further, there is no dependency of MAC grants on the NRT functionalities because of the byte offset indicated by the NRT layer (311) to the RT layer (313). Also, in case of any segmentation to be performed, the MAC layer (111) performs the segmentation. The Below the RT layer (313) is a physical layer (113) that transmits the IP packets through the physical channel over the wireless communication network.

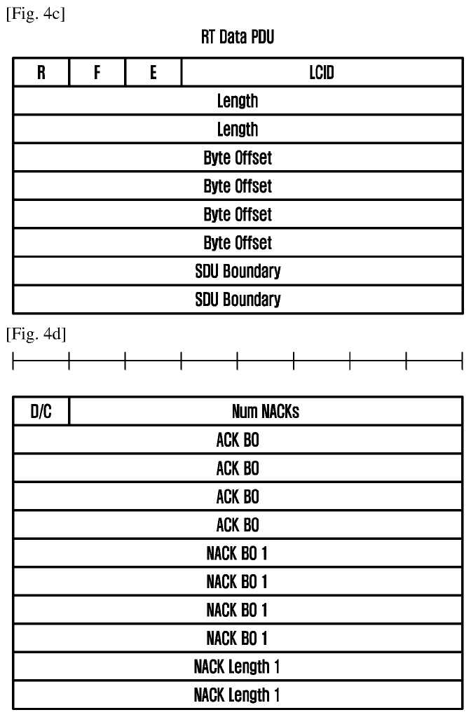

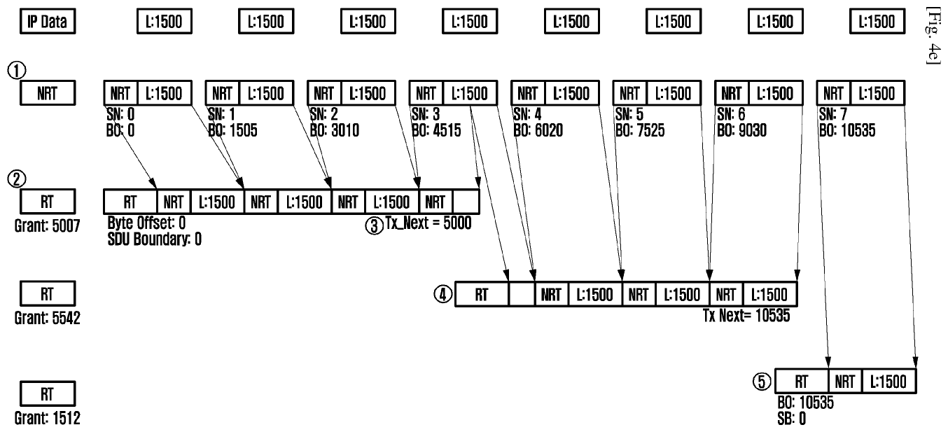

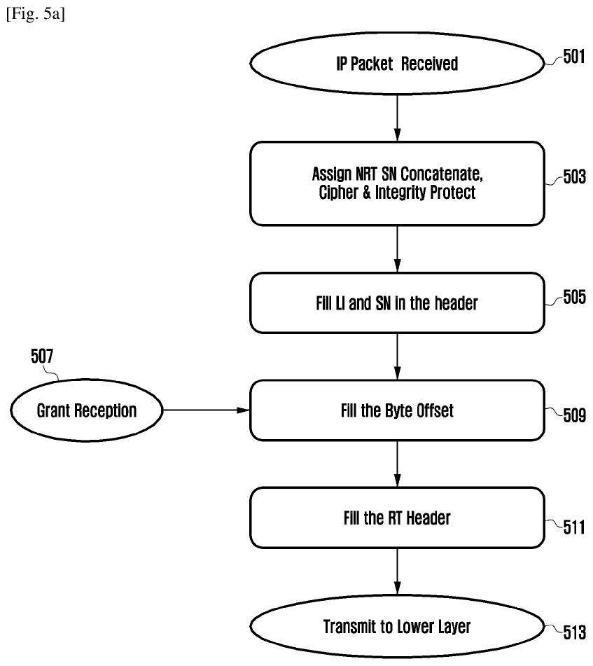

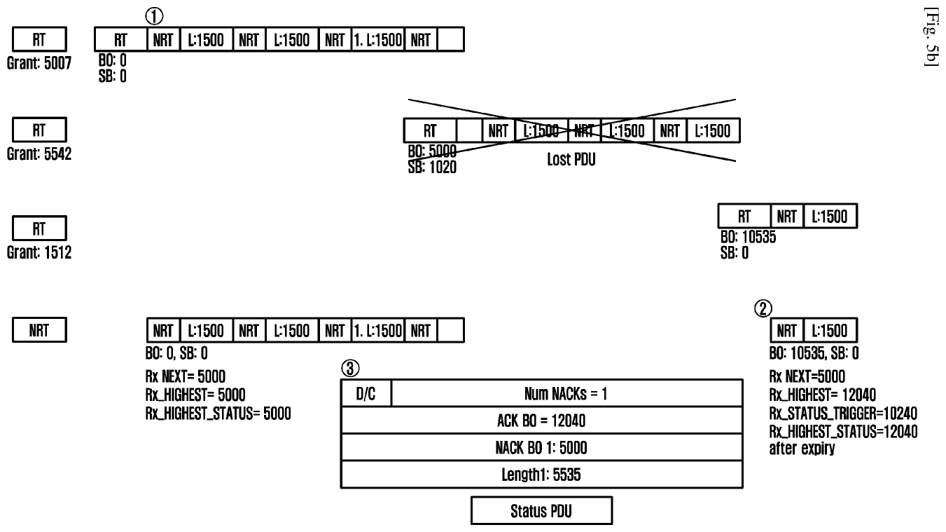

FIG. 4A is a packet structure including the NRT header and RT header, according to the embodiment as disclosed herein. FIG. 4A represents a transport block formed by adding both the NRT header at the NRT layer (311) and the RT header at the RT layer (313). The NRT header to each of the SDU packets received from the upper layers. Further, the NRT layer generates a plurality of PDU packet by combining the plurality of SDU packets. For example, a PDU packet can be a combination 4 SDU packets which is of the length 1500 each as shown in FIG. 4. Further, the RT layer (313) adds the RT header to the PDU packet. For example, a single RT header is added to a combined PDU packet (combination of 4 SDU packet) to form a single Transport Block (TB). At the RT layer, a segmentation of the PDU packet is possible based on the grans received from the network. is added by combining plurality of SDU packets received from the NRT.

FIG. 4B depicts a NRT header structure for data PDU, according to the embodiment as disclosed herein. The NRT header is added at the NRT layer (311) for each of the SDU packets. The NRT header comprises several fields like a D/C bit, P bit, Sequence number (SN) field and a length indicator field. The D/C bit indicates whether SDU packet includes the packet data information or a control information. The D:1 indicates that packet data information is present in the SDU packet. Similarly, when C is set to “1” then the SDU packet includes the control information. Further the P bit indicates. Also, the sequence number is a unique number assigned to each of the SDU packet, so that the receiver can keep the track of the received SDU packets. Further, the length indicator field indicates the length of the each SDU packet.

FIG. 4C depicts a RT header structure for data PDU, according to the embodiment as disclosed herein. The RT header is added at the RT layer (313). The RT layer adds the RT header to a combined plurality of SDU packets. The combined plurality of SDU packets is referred to as a PDU packet. Particularly, the RT layer (313) adds the RT header to each of the PDU packet to form a TB. The RT header includes a R bit, F bit, E bit, LCID field, length indicator field, byte offset and SDU boundary. The E bit is a single bit indication to determine whether the TB is followed by another RT header. When E is set to “0” then it indicates that there is no following RT header. Similarly, when E is set to “1” then it indicates that there is another RT header following the TB. The LCID represents a logical channel ID of the TB for multiplexing. The length indicator indicates the length of the PDU packet. The byte offset of each SDU packet is included in the RT header as indicated by the NRT layer. The SDU boundary indicates the offset at which the first SDU starts. Also, there is additional no sequence number added to the PDU. The RT header is a simplified header that is applicable for both segmented PDU packet and the non-segmented PDU packet.

FIG. 4D depicts a header structure for status PDU, according to the embodiment as disclosed herein. FIG. 4D represents the status PDU transmitted by the NRT layer (311) at the receiver device. The status PDU indicates the status of the SDU packets that are received successfully and not received successfully. The status PDU includes a D/C bit, total number of Negative acknowledgements (numNACKs), Acknowledgement of received byte offset (ACK BO), negative acknowledgement of not received byte offset (NACK BO), the length of the not received SDU packet (NACK length 1). The ACK BO indicates the byte offset of the successfully received SDU packets. The NACK BO indicates the byte offset of the not received SDU packets. The length filed indicates the length of the SDU packet that are not received at the receiver device. Also, the num NACKs indicates the total number of NACK BO.

FIG. 4E illustrates a scenario of packet processing during transmit procedure of SDUs through the NRT layer and RT layer, according to the embodiment as disclosed herein. For example, as shown in FIG. 4E, consider during a transmit procedure, one or more IP packets (SDU packets) are received by the NRT layer (311) from the upper layer. Each of the SDU packets can be of the length 1500 bytes. Further, at step 1, the NRT layer (311), adds the NRT header to each of the SDU packet. Also, the NRT layers assigns the sequence number to each of the SDU packet and fills the assigned sequence number in the NRT header. The first SDU packet can have a SN=0, with byte offset value 0. Further, the second SDU packet to eighth SDU packet can have the sequence number and byte offset value as (SN=1, BO=1505), (SN=2, BO=3010), (SN=3, BO=4515), (SN=4, BO=6020), (SN=5, BO=7525), (SN=6, BO=9030), and (SN=7, BO=10535) respectively. The NRT layer (311) indicates the offset value based on the length of the SDU packet and the size of the NRT header of the SDU packet. The NRT SN is used for ciphering and integrity protection. In an embodiment, during null-ciphering/integrity the SN can be avoided. Furthermore, the NRT layer (311) combines or concatenates the one or more SDU packets to form the plurality of PDU packets. Thereafter, the NRT layer (311) transmits the plurality of PDU packets to the RT layer (313). Also, the NRT layer (311) maintains a transaction window based on the byte offsets but not based on the sequence number.

Upon receiving the plurality of PDU packets, the RT layer (313) stores the plurality of PDU packets. Also, upon the reception of the grant at step 2, the RT layer (313) includes the RT header to each of plurality of PDU packet based on the grant received. The RT layer (313) can segment the PDU packet if the grant received is less than the size of the PDU packet. For example, at step 3, the RT header is added to a first PDU packet, where the first PDU packet is formed by combining the first SDU, the second SDU, the third SDU and the first half of fourth SDU packet. Similarly, at step 4, the RT layer (313) adds the RT header to the second PDU packet when a grant of 5007 bytes is received, where the second PDU packet is formed by combining the second half of the fourth SDU packet, fifth SDU packet, sixth SDU packet, and the seventh SDU packet. Also, at step 5, the RT layer (313) adds the RT header to the eighth SDU packet, when the grant received is 1512. The RT layer (313) fills the various fields in the RT header. The RT layer (313) fills the byte offset of the first SDU in the PDU packet and the total length of the PDU packet in the RT header. Also, the RT layer (313) fills the LCID filed and the SDU boundary filed in the RT header. The addition of the RT header to the plurality of PDU packets forms the plurality of TBs. Also, the RT layer (313) stores the byte offset segmented SDU which is not transmitted that is indicated as Tx_next. For example, the RT header of the first PDU packet can include the Tx_next as 5000. Similarly, the RT header in the second PDU packet can include the Tx_next as 10535. The segmented part of the PDU packet will be transmitted based on the Tx_next value. Furthermore, the RT layer sends the plurality of TBs to the lower layers.

Also, the RT layer (313) stores state variables along with the RT header for the efficient transmission of the transport block towards the lower layers. The state variables stored by the RT layer (313) is as shown in below table 1:

TABLE 1

| State Variable | Meaning |
|---|---|
| Tx_Next_Ack | Acknowledgement Byte |
| Tx_Next | Next Byte to be sent |
| Tx_Poll | Byte Offset for which poll was sent |
| Rx_Next | First missing byte offset |
| Rx_Highest_Status | Byte up to which status can be sent |
| Rx_Next_Status_Trigger | Byte for which T-reassembly is |
| | triggered |
| Rx_Highest | Highest received byte + 1 |

FIG. 5A is a flow diagram that illustrates a packet processing during transmit procedure of SDUs through the NRT layer and RT layer, according to the embodiment as disclosed herein.

At block 501, the apparatus when performing a transmit procedure, the NRT layer (311) receives plurality of IP packets from the upper layers.

At block 503, the NRT layer (311) assigns NRT SN to each of the SDU packet. Also, the NRT layer (311) performs concatenation, ciphering and integrity protection to each of the SDU packet.

At block 505, the NRT layer (311) adds the NRT header to each of the SDU packet. The NRT layers (311) fills the length indicator and the NRT SN in the NRT header. Further, the NRT layer (311) transmits the plurality of SDU packets to the RT layer (313). The NRT layer (311) can combine the plurality of SDU packets to form a PDU packet.

At block 507, a grant is received by the RT layer (313) by the wireless communication network.

At block 509, the RT layer (313) process the plurality of PDU packets based on the grant received and adds the RT header to each of the PDU packet. The RT layer (313) can perform the segmentation of the at least one of the PDU packet based on the reception of the grant. Also, the RT layer (313) fills the byte offset of each SDU packet as received by the NRT layer (311).

At block 511, the RT layer (313) fills the RT header to each of the PDU packets. Particularly, the RT layer (313) fills the length of the PDU packet, byte offset of first SDU packet in the PDU packet, the SDU boundary and the LCID in the RT header. Also, the Ebit can be filled, indicating whether the PDU packet is followed by another RT header. The RT layer (313) adds the RT header to the plurality of PDU packet to form the plurality of Transport Block.

At block 513, the RT layer (313) transmits the plurality of transport blocks to the lower layers.

FIG. 5B illustrates a scenario of packet processing during receive procedure of SDUs through the NRT layer and RT layer, according to the embodiment as disclosed herein. FIG. 5B represents a scenario of processing the IP packets received by the apparatus (301). Consider a plurality of TBs is received at is transmitted by the transmitter device. The apparatus being a receiver device, at step 1 consider the RT layer (313) of the apparatus receives the plurality of TBs from the transmitter device. Further, the RT layer (313) transmits the plurality of TBs to the NRT layer (311).

Furthermore, at step 2, the NRT layer (311) detects the lost PDU packet based on the byte offset and the SDU boundary. For example, consider the first PDU packet (having Byte offset: 0 and SDU boundary (SB): 0), is received. Further, a third PDU packet having the BO: 10535 and SB: 0 is received. Thus, the NRT layer (311) determines that the second PDU packet is not received that is having the BO: 5000 and the SB: 1020. The determination is made by considering the BO of the first PDU packet (0), length of the first PDU packet (5000), BO of third PDU packet (10535), the SDU boundary of the first PDU packet and the SDU boundary of the third PDU packet. However, the second PDU packet is not received. Furthermore, the RT layer can determine the missing PDU packet by reading the byte offset value and the SDU boundary of the received PDU packet. Upon detecting the second PDU packet loss, the NRT layer (311) initiates the T-reassembly timer.

Further, at step 3, the NRT layer (311) generates a status PDU to report the transmitter about the status at the receiver side. The status PDU includes a one or more fields that indicates the successfully received IP packets and the not received IP packets. Particularly, the NRT layer (311) fills the total number of Negative acknowledgements (numNACKs), Acknowledgement of received byte offset (ACK BO), negative acknowledgement of not received byte offset (NACK BO), the length of the not received SDU packet (NACK length 1) in the status PDU. For example, since the second PDU packet was not received the numNACKs will have a value “1”. Further, the ACKBO will have the value “12040”. Furthermore, the NACKBO will have the value “5000”. Also, the NACKlength will have the value “5535”.

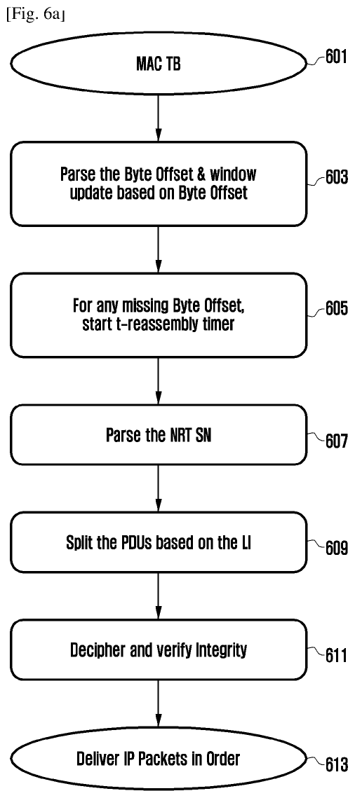

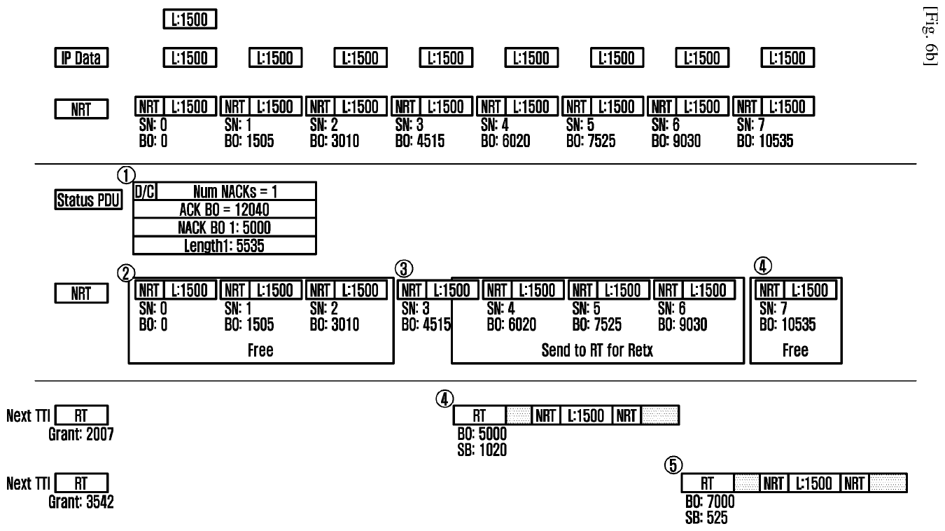

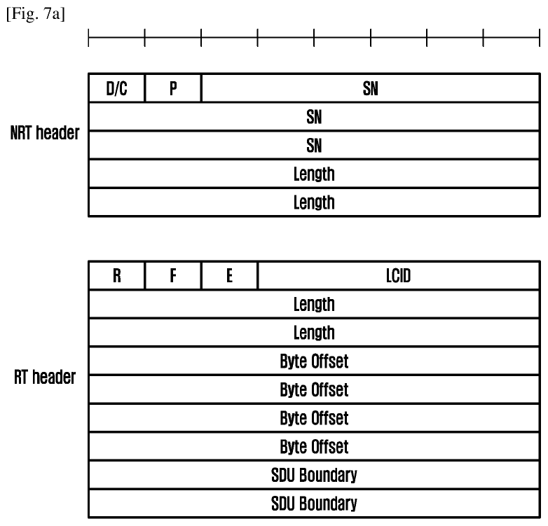

FIG. 6A is a flow diagram that illustrates a packet processing during receive procedure of SDUs through the NRT layer and RT layer, according to the embodiment as disclosed herein.

At block 601, the apparatus (301) being a receiver device, receives plurality of TBs at the RT layer (313) from the transmitter device. Further, the RT layer (313) parses the plurality of TBs and removes the RT header to form the plurality of PDU packets. Further, the RT layer (313) transmits the plurality of PDU packets to the NRT layer (311).

At block 603, the NRT layer (311) receives the plurality of PDU packets. Also, the NRT layer (311) parses the byte offset and performs the window update based on the byte offset.

At block 605, upon parsing, the NRT layer (311) determines the missing byte offset based on the byte offset, length and SDU boundary of the received PDU packets. Also, the NRT layer (311) starts the t-reassembly timer. Further, the NRT layer (311) transmits the status PDU indicating the status of the one or PDU packets at the receiver device.

At block 607, the NRT layer (311) parses the sequence number associated with each of the SDU packets in the PDU packet.

At block 609, the NRT layer (311) splits the PDU packets into the plurality of SDU packets based on the length indicator indicated in the NRT header.

At block 611, the NRT layer (311) performs ciphering and verifies the integrity of the plurality of SDU packets.

At block 613, upon the successful integrity verification the NRT layer (311) transmits the plurality of SDU packets to the upper layers.

FIG. 6B illustrates a scenario of retransmission procedure, according to the embodiment as disclosed herein. FIG. 6B represents a transaction window to maintain the one or more SDU packets in the buffer. The apparatus (301) being a transmitter device maintains the transmission window and buffers the one or more SDU packets. Also, at step 1, the apparatus (301) stores the status PDU received from the receiver side. Further, at step 2 the apparatus (301) can free the buffer by removing the one or more PDU packets that has received successfully at the receiver side. For example, when the status PDU having the ACKBO as 12040, NACKBO as 5000 and NACK length as 5535, step 2, the NRT layer (311) of the apparatus (301) frees the buffer space that was storing the one or more SDU packets of the PDU packets having the byte offset 12040. At step 3, Also, the NRT layer (311) prepares for the retransmission of the PDU packet having the BO 5000 with length 5535. Similarly, at step 4 the NRT layer (311) free the buffer that was storing the PDU packet having the byte offset 12040.

Also at step 4, during the retransmission, the RT layer (313) of the apparatus can segment the PDU packet based on the grant received from the wireless communication network. Due to the segmentation, the length of the PDU packet is changed as 2000 and updates the byte offset of the not transmitted segments as 7000.

Furthermore, at step 5, upon the reception of the subsequent grant, the RT layer (313) transmits the rest of the PDU packet having the byte offset 7000.

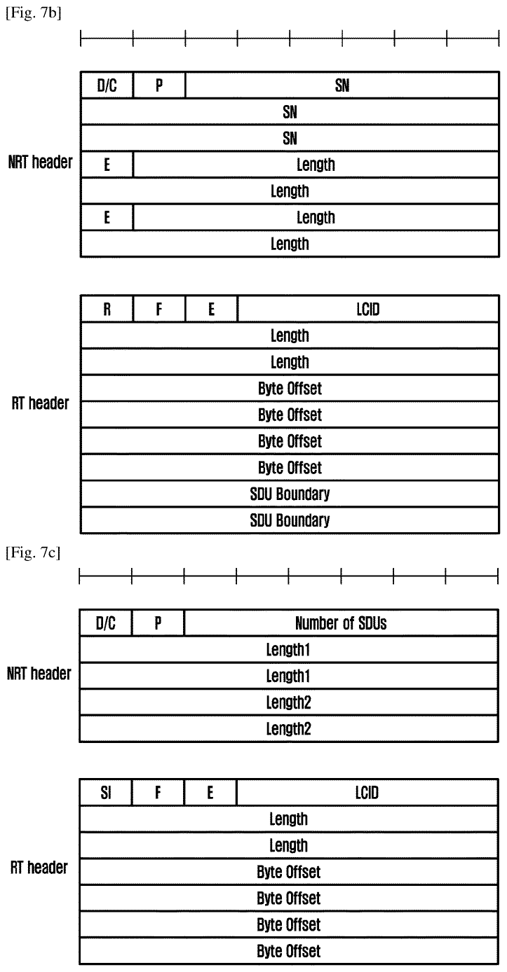

FIG. 7A-7C is a header structure of a NRT PDU and RT PDU, according to the embodiment as disclosed herein.

In an embodiment, as shown in FIG. 7A each NRT PDU can contain exactly one SDU. Also, the NRT layer (311) shares the byte offset of the SDU packet to the RT layer (313). Further, the RT layer (313) checks the byte offset and length of the NRT PDU and concatenates one or more NRT PDUs. The RT layer (313) adds the RT header to the concatenated NRT PDUs. In such cases, the updation of length fields to split SDUs is not required.

In an embodiment, as shown in FIG. 7B the NRT layer (311) can concatenate a fixed number of SDUs in one PDU to form a NRT PDU. Also, the NRT header must include the length sub header to indicate the boundaries between the SDUs. Further, the NRT header contains an extra first SDU length indicator to indicate the start of the next independent SDU. Furthermore, the first SDU length indicator helps during the reassembly of the NRT PDU at the receiver side to identify the dropped segments.

In an embodiment, as shown in FIG. 7C the NRT layer (311) can concatenate multiple SDUs by including the number of SDUs concatenated. The number of SDUs in the NRT PDU is indicated in the NRT header. Also, no sequence numbers are included in the NRT header but updates only the length fields, where the length fields indicate the length of the SDUs. During the segmentation, the NRT layer (311) enables SI field to indicate middle or end segment of the SDU. Furthermore, the RT layer (313) does not include the SDU boundary in the RT header, since the number of SDUs along with the length is indicated in the NRT header.

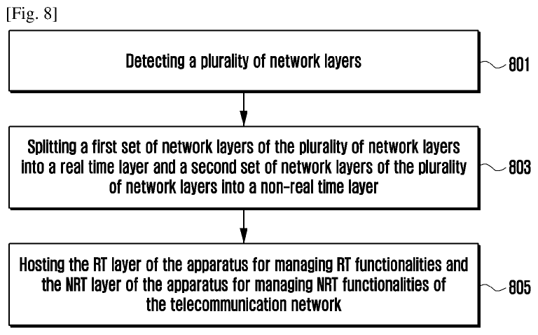

FIG. 8 is a flow diagram that illustrates a method of hosting real time layer and non-real time layer in telecommunication network, according to the embodiments herein.

At block 801, the apparatus (301) detects the plurality of network layers. The apparatus can be at least one of a user equipment or a network apparatus. Also, the apparatus (301) can be transmitter device while transmitting the IP packets. Similarly, the apparatus (301) can be receiver device while receiving the IP packets.

At block 803, the apparatus (301) splits a first set of network layers of the plurality of network layers into a real time layer (311) and a second set of network layers of the plurality of network layers into a non-real time layer (313).

At block 805, the apparatus (301) hosts the RT layer (311) of the apparatus for managing RT functionalities and the NRT layer (313) of the apparatus for managing NRT functionalities of the telecommunication network.

The proposed invention offers significant technical value by introducing a method to distinctly segregate non-real time and real time processing through the implementation of NRT and RT headers during IP packet processing in telecommunication networks. This segmentation of NRT and RT functionalities simplifies the usage of sequence numbers, as each SDU packet at the NRT layer is assigned a sequence number, while no sequence number is added at the RT layer. This results in a reduction of sequence numbers, thereby reducing processing overhead at the receiver side. Furthermore, the proposed invention maintains consistent header information, regardless of whether the IP packet is fully transmitted or not, ensuring efficient handling of payloads packed in the transport block. The proposed solution also employs a status PDU structure based on byte offsets, eliminating the need to maintain the number of lost SDUs. By avoiding the usage of SN in real-time handling and relying solely on a segmentation offset solution, the proposed invention provides a window purely based on byte offset.

The proposed invention offers an innovative and efficient solution for wireless ARQ mechanism between BS and UE, with reduced overhead of headers and processing to support higher throughput. This idea caters to the high throughput requirements of the 6th generation while minimizing processing overhead. The solution achieves this feat without relying on high power processors, making it a practical option for supporting ESG targets. The prior art does not disclose the maintenance of state variables in terms of Byte offset rather than Sequence Number, which is a completely new protocol variant for 6G standardization. The proposed solution retains all the advantages and purposes of RLC protocol while avoiding implementation complexities for vRAN systems. The processing at the modem and RAN is directly proportional to the number of packets and independent of packet size. The proposed method simplifies the protocol structure by removing the RLC SN and keeping only the Segment/Byte Offset field in the header, effectively decoupling RLC and MAC and easing microservice-based cloud deployment.

The technical solution can be detected through the standardization of protocol headers in 3GPP 6G or advance technological releases. Any logger that captures over-the-air packets of the 6G or advance protocol would be capable of detecting the packet header formats. The transmitter's packet formats provide a straightforward means of detection. Additionally, a detailed examination of the logs from either the Application Processor or Modem Processor, which reveal the internal operations of the module's processing, can also uncover the technical solution.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

List of reference numerals:

| Reference | |
|---|---|
| Numerals | Description |
| 101 | Application layer |
| 103 | IP layer |
| 105 | SDAP layer |
| 107 | PDCP layer |
| 109 | RLC layer |
| 111 | MAC layer |
| 113 | Physical layer |
| 115 | Ip packet |
| 117 | SDAP SDU |
| 119 | PDCP SDU |
| 121 | RLC SDU |
| 123 | MAC SDU |
| 125 | Transport block |
| 127 | Centralized Unit (CU) |
| 129 | Distributed Unit (DU) |
| 301 | Apparatus |
| 303 | Processor |
| 305 | I/O interface |
| 307 | Memory |
| 309 | Hosting controller |
| 311 | Non-real time layer (NRT) |
| 313 | Real time layer (RT) |

1. A method of splitting Real Time (RT) and Non-Real Time (NRT) functionality in a telecommunication network, comprises:
detecting, by an apparatus (301), a plurality of network layers, wherein the plurality of network layers is at least one of an application layer, Internet Protocol Layer, service data adaption protocol layer, packet data convergence protocol layer, radio link control layer, Medium access control layer and a physical layer;
splitting, by the apparatus (301), a first set of network layers of the plurality of network layers into a real time layer and a second set of network layers of the plurality of network layers into a non-real time layer; and
hosting, by the apparatus (301), the RT layer (313) of the apparatus (301) for managing RT functionalities and the NRT layer (311) of the apparatus (301) for managing NRT functionalities of the telecommunication network.

2. The method of claim 1, wherein hosting, by the apparatus (301) for transmission, the RT layer (313) for managing RT functionalities and the NRT layer (311) for managing NRT functionalities of the telecommunication network comprising:
receiving, by the NRT layer (311) of the apparatus (301), a plurality of Service Data Unit (SDU) packets;
adding, by the NRT layer (311) of the apparatus (301), a NRT header to the plurality of SDU packets, wherein the NRT header comprises Data or Control bit information, a sequence number and a length indicator of SDU packet;
generating, by the NRT layer (311) of the apparatus (301), a plurality of Protocol Data Unit (PDU) packets by concatenating the plurality of SDU packets;
determining, by the NRT layer (311) of the apparatus (301), a PDU byte offset for each PDU packet of the plurality of PDU packets;
generating, by the RT layer (313) of the apparatus (301), a plurality of Transport Block (TB) by adding a RT header to a set of PDU packets of the plurality of PDU packets along with the corresponding PDU byte offset, wherein the RT header comprises a start byte offset of the set of PDU packets, a SDU boundary of the set of PDU packets, and a length indicator of the set of PDU packets; and
transmitting, by the RT layer (313) of the apparatus (301), the plurality of TBs to the apparatus.

3. The method of claim 2, wherein generating, by the RT layer (313) of the apparatus (301), a plurality of TB by adding a RT header to the set of PDU packets of the plurality of PDU packets along with the corresponding PDU byte offset comprises:
transmitting, by the NRT layer (311) of the apparatus (301), each PDU packet of the plurality of PDU packets along with the PDU byte offset of each PDU packet of the plurality of PDU packets to the RT layer (313);
receiving, by the RT layer (313) of the apparatus (301), each PDU packet of the plurality of PDU packets along with the PDU byte offset of each PDU packet of the plurality of PDU packets to the RT layer (313);
storing, by the RT layer (313) of the apparatus (301), each PDU packet of the plurality of PDU packets along with the PDU byte offset of each PDU packet of the plurality of PDU packets to the RT layer (313);
determining, by the RT layer (313) of the apparatus (301), grants available at the apparatus; and
generating, by the RT layer (313) of the apparatus (301), the plurality of TB by adding the RT header to the set of PDU packets based on the grants available at the apparatus.

4. The method of claim 2, wherein adding the RT header to the set of PDU packets based on the grants available at the apparatus (301) comprises:
determining, by the RT layer (313) of the apparatus (301), whether the grants available at the apparatus (301) is sufficient to add the RT header to the set of PDU packets;
performing, by the RT layer (313) of the apparatus (301), one of:
concatenating the set of PDU packets when the grants available at the apparatus (301) is sufficient to add the RT header to the set of PDU packets, and adding the RT header to the set of concatenated PDU packets,
segmenting the set of PDU packets into a plurality of subset of PDU packets when the grants available at the apparatus (301) is not sufficient to add the RT header to the set of PDU packets, and adding the RT header to a subset of the plurality of subset of PDU packets,
generating, by the NRT layer (311), the NRT header comprising a data or a control bit information, a sequence number and a length indicator of SDU packet;
performing, by the NRT layer (311), one of:
adding the NRT header to each SDU packet of the plurality of SDU packets; and
concatenating a set of SDU packets from the plurality of SDU packets and adding the NRT header to the set of concatenated SDU packet, wherein the set of SDU packets are predefined or randomly determined, wherein the PDU byte offset for each PDU packet of the plurality of PDU packets are determined contiguously.

5. The method of claim 2, comprising:
receiving, by the RT layer (313) of the apparatus (301), a status PDU indicating status of plurality of transmitted PDU packets;
determining, by the NRT layer (311), the set of not received PDU packets and length of the set of not received PDU packets for retransmission based on the status PDU; and
retransmitting, by the NRT layer (311), the set of not received PDU packets to the apparatus.

6. The method of claim 1, wherein hosting, by the apparatus (301) for reception, the RT layer (313) for managing RT functionalities and the NRT layer (311) for managing NRT functionalities of the telecommunication network comprising:
receiving, by a RT layer (313) of the apparatus (301), at least one TB from a plurality of TBs, wherein the at least one TB comprises a RT header associated with a set of PDUs;
obtaining, by the RT layer (313) of the apparatus (301), a start byte offset of the set of PDU packets, a SDU boundary of the set of PDU packets, and a length indicator of the set of PDU packets from the RT header of each TB of the plurality of TBs;
sending, by the RT layer (313) of the apparatus (301), the set of PDU packets to a NRT layer (311) of the apparatus (301), wherein each PDU packet is associated with a NRT header comprising Data or Control bit information, a sequence number and a length indicator of SDU packet;
obtaining, by the NRT layer (311) of the apparatus (301), individual PDU packets by splitting the set of PDU packets based on a Data or a Control bit information, the sequence number, the start byte offset of the PDU packet, and the length indicator of SDU packet; and
transmitting, by the NRT layer (311) of the apparatus (301), a status PDU to the apparatus.

7. The method of claim 1, further comprises:
determining, by the NRT layer (311) of the apparatus (301), whether all TBs of the plurality of TBs are received based on the start byte offset of the set of PDU packets, a SDU boundary of the set of PDU packets, and the length indicator of the set of PDU packets; and
starting, by the NRT layer (311) of the apparatus (301), a reassembly timer to receive remaining TB of the of the plurality of TBs when all TBs of the plurality of TBs are not received, wherein the status PDU comprises the start byte offset of the set of received PDU packets, start byte offset of the set of not received PDU packets, length of the each of the not received PDU packet and total number of sets of PDU packets that are not received by the apparatus.

8. An apparatus (301) for splitting RT and NRT functionality in a telecommunication network comprises:
a processor (303); and
a hosting controller (309), communicatively coupled to the processor (303), configured to:
detect a plurality of network layers, wherein the plurality of network layers is at least one of an application layer, Internet Protocol Layer, service data adaption protocol layer, packet data convergence protocol layer, radio link control layer, Medium access control layer and a physical layer;
split a first set of network layers of the plurality of network layers into a real time layer (313) and a second set of network layers of the plurality of network layers into a non-real time layer (311); and
host the RT layer (313) of the apparatus (301) for managing RT functionalities and the NRT layer (311) of the apparatus (301) for managing NRT functionalities of the telecommunication network.

9. The apparatus (301) of claim 8, wherein to host, during transmission, the RT layer (313) for managing RT functionalities and the NRT layer (311) for managing NRT functionalities of the telecommunication network is configured to:
receive, by the NRT layer (311) of the apparatus (301), a plurality of Service Data Unit (SDU) packets;
add, by the NRT layer (311) of the apparatus (301), a NRT header to the plurality of SDU packets, wherein the NRT header comprises Data or Control bit information, a sequence number and a length indicator of SDU packet;
generate, by the NRT layer (311) of the apparatus (301), a plurality of Protocol Data Unit (PDU) packets by concatenating the plurality of SDU packets;
determine, by the NRT layer (311) of the apparatus (301), a PDU byte offset for each PDU packet of the plurality of PDU packets;
generate, by the RT layer (313) of the apparatus (301), a plurality of Transport Block (TB) by adding a RT header to a set of PDU packets of the plurality of PDU packets along with the corresponding PDU byte offset, wherein the RT header comprises a start byte offset of the set of PDU packets, a SDU boundary of the set of PDU packets, and a length indicator of the set of PDU packets; and
transmit, by the RT layer (313) of the apparatus (301), the plurality of TBs to the apparatus.

10. The apparatus (301) of claim 9, wherein to generate, by the RT layer (313) of the apparatus (301), a plurality of TB by adding a RT header to the set of PDU packets of the plurality of PDU packets along with the corresponding PDU byte offset comprises:
transmit, by the NRT layer (311) of the apparatus (301), each PDU packet of the plurality of PDU packets along with the PDU byte offset of each PDU packet of the plurality of PDU packets to the RT layer (313);
receive, by the RT layer (313) of the apparatus (301), each PDU packet of the plurality of PDU packets along with the PDU byte offset of each PDU packet of the plurality of PDU packets to the RT layer (313);
store, by the RT layer (313) of the apparatus (301), each PDU packet of the plurality of PDU packets along with the PDU byte offset of each PDU packet of the plurality of PDU packets to the RT layer (313);
determine, by the RT layer (313) of the apparatus (301), grants available at the apparatus (301); and
generate, by the RT layer (313) of the apparatus (301), the plurality of TB by adding the RT header to the set of PDU packets based on the grants available at the apparatus.

11. The apparatus (301) of claim 9, wherein to add the RT header to the set of PDU packets based on the grants available at the apparatus (301) comprises:
determine, by the RT layer (313) of the apparatus (301), whether the grants available at the apparatus (301) is sufficient to add the RT header to the set of PDU packets;
perform, by the RT layer (313) of the apparatus (301), one of:
concatenate the set of PDU packets when the grants available at the apparatus (301) is sufficient to add the RT header to the set of PDU packets, and adding the RT header to the set of concatenated PDU packets,
segment the set of PDU packets into a plurality of subset of PDU packets when the grants available at the apparatus (301) is not sufficient to add the RT header to the set of PDU packets, and adding the RT header to a subset of the plurality of subset of PDU packets
generate, by the NRT layer (311), the NRT header comprising the data or control bit information, the sequence number and the length indicator of SDU packet;
perform, by the NRT layer (311), one of:
add, by the NRT layer (311), the NRT header to each SDU packet of the plurality of SDU packets; and
concatenate, by the NRT layer (311), a set of SDU packets from the plurality of SDU packets and adding the NRT header to the set of concatenated SDU packet, wherein the set of SDU packets are predefined or randomly determined, wherein the PDU byte offset for each PDU packet of the plurality of PDU packets are determined contiguously.

12. The apparatus (301) of claim 9, is configured to receive, by the RT layer (313) of the apparatus (301), the status PDU indicating the status of plurality of transmitted PDU packets;
determine, by the NRT layer (311), the set of not received PDU packets and the length of the set of not received PDU packets for retransmission based on the status PDU; and
retransmit, by the NRT layer (311), the set of not received PDU packets to the apparatus.

13. The apparatus (301) of claim 8, wherein to host, during reception, the RT layer (313) for managing RT functionalities and the NRT layer (311) for managing NRT functionalities of the telecommunication network comprises:
receive, by a RT layer (313) of the apparatus (301), at least one TB from a plurality of TBs, wherein the at least one TB comprises a RT header associated with a set of PDUs;
obtain, by the RT layer (313) of the apparatus (301), a start byte offset of the set of PDU packets, a SDU boundary of the set of PDU packets, and a length indicator of the set of PDU packets from the RT header of each TB of the plurality of TBs;
send, by the RT layer (313) of the apparatus (301), the set of PDU packets to a NRT layer (311) of the apparatus (301), wherein each PDU packet is associated with a NRT header comprising Data or Control bit information, a sequence number and a length indicator of SDU packet;
obtain, by the NRT layer (311) of the apparatus (301), individual PDU packets by splitting the set of PDU packets based on the Data or Control bit information, the sequence number, the start byte offset of the PDU packet, and the length indicator of SDU packet; and
transmit, by the NRT layer (311) of the apparatus (301), a status PDU to the apparatus.

14. The apparatus (301) of claim 13, configured to:
determine, by the NRT layer (311) of the apparatus (301), whether all TBs of the plurality of TBs are received based on the start byte offset of the set of PDU packets, the SDU boundary of the set of PDU packets, and the length indicator of the set of PDU packets; and
start, by the NRT layer (311) of the apparatus (301), a reassembly timer to receive remaining TB of the of the plurality of TBs when all TBs of the plurality of TBs are not received.

15. The apparatus (301) of claim 13, wherein the status PDU comprises the start byte offset of the set of received PDU packets, start byte offset of the set of not received PDU packets, length of the each of the not received PDU packet and total number of sets of PDU packets that are not received by the apparatus.
